(19) United States
(12) Patent Application Publication
(10) Pub. No.: US 2011/0205148 A1
(43) Pub. Date: Aug. 25, 2011

(54) Facial Tracking Electronic Reader

(76) Inventors: Philip J. Corriveau, Forest Grove, OR (US); Glen J. Anderson, Beaverton, OR (US)

(21) Appl. No.: 12/711,329

(22) Filed: Feb. 24, 2010

(51) Int. Cl. G06F 3/01

(52) U.S. Cl. 345/156; 348/78

(57) ABSTRACT

Facial actuations, such as eye actuations, may be used to detect user inputs to control the display of text. For example, in connection with an electronic book reader, facial actuations and, particularly, eye actuations, can be interpreted to indicate when the turn a page, when to provide a pronunciation of a word, when to provide a definition of a word, and when to mark a spot in the text, as examples.

### BACKGROUND

This relates generally to electronic readers which may include any electronic display that displays text read by the user. In one embodiment, it may relate to a so-called electronic book which displays, page-by-page on an electronic display, the text of a book.

Electronic books, or e-books, have become increasing popular. Generally, they display a portion of the text and then the user must manually manipulate user controls to bring up additional pages or to make other control selections. Usually, the user touches an icon on the display screen in order to change pages or to initiate other control selections. As a result, a touch screen is needed and the user is forced to interact with that touch screen in order to control the process of reading the displayed text.

### BRIEF DESCRIPTION OF THE DRAWINGS

FIG. 1 is a front elevational view of one embodiment of the present invention;

FIG. 2 is a schematic depiction of the embodiment shown in FIG. 1 in accordance with one embodiment;

FIG. 3 is a flow chart for one embodiment of the present invention; and

FIG. 4 is a more detailed flow chart for one embodiment of the present invention.

### DETAILED DESCRIPTION

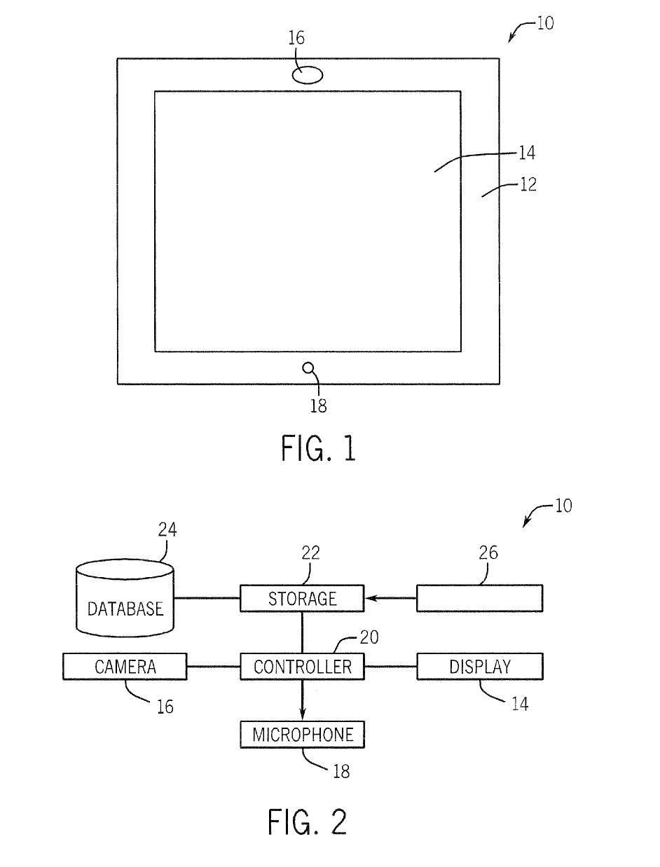

Referring to FIG. 1, an electronic display 10 may display text to be read by a user. The display 10 may, in one embodiment, be an electronic book reader or e-book reader. It may also be any computer display that displays text to be read by the user. For example, it may be a computer display, a tablet computer display, a cell phone display, a mobile Internet device display, or even a television display. The display screen 14 may be surrounded by a frame 12. The frame may support a camera 16 and a microphone 18, in some embodiments.

The camera 16 may be aimed at the user's face. The camera 16 may be associated with facial tracking software that responds to detected facial actuations, such as eye or facial expression or head movement tracking. Those actuations may include any of eye movement, gaze target detection, eye blinking, eye closure or opening, lip movement, head movement, facial expression, and staring, to mention a few examples.

The microphone 18 may receive audible or voice input commands from the user in some embodiments. For example, the microphone 18 may be associated with a speech detection/recognition software module in one embodiment.

Referring to FIG. 2, in accordance with one embodiment, a controller 20 may include a storage 22 on which software 26 may be stored in one embodiment. A database 24 may also store files, including textual information to be displayed on the display 14. The microphone 18 may be coupled to the controller 20, as may be the camera 16. The controller 20 may implement eye tracking capabilities using the camera 16. It may also implement speech detection and/or recognition using the microphone 18.

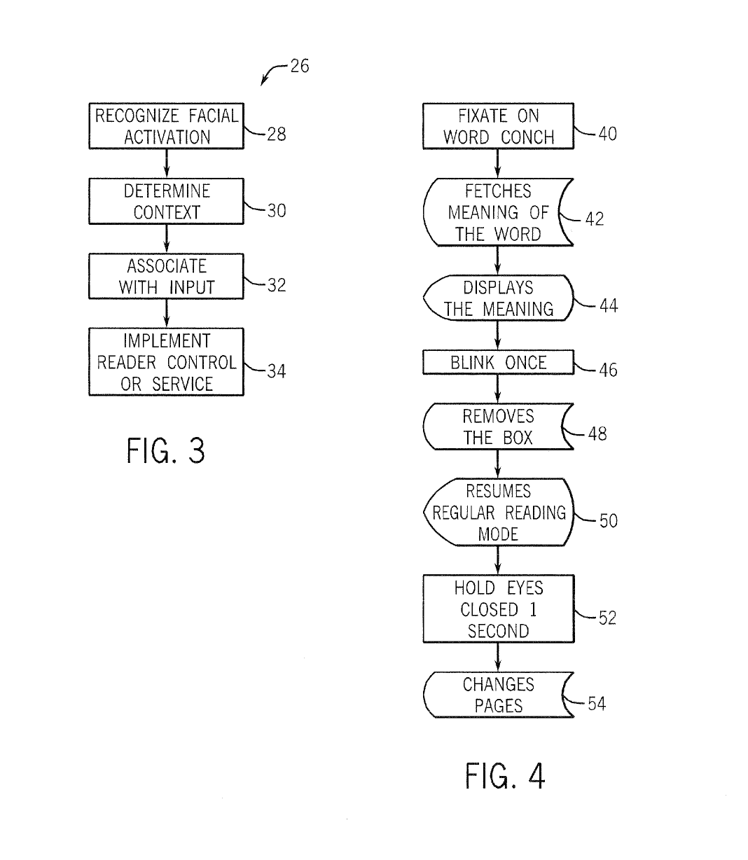

Referring to FIG. 3, in a software embodiment, a sequence of instructions may be stored in a computer readable medium, such as the storage 22. The storage 22 may be an optical, magnetic, or semiconductor memory, to mention typical examples. In some embodiments, the storage 22 may constitute a computer readable medium storing instructions to be implemented by a processor or controller which, in one embodiment, may be the controller 20.

Initially, a facial activity is recognized, as indicated in block 28. The activity may be recognized from a video stream supplied from the camera 16 to the controller 20. Facial tracking software may detect movement of the user's pupil, movement of the user's eyelids, facial expressions, or even head movements, in some embodiments. Image recognition techniques may be utilized to recognize eyes, pupils, eyelids, face, facial expression, or head actuation and to distinguish these various actuations as distinct user inputs. Facial tracking software is conventionally available.

Next, the facial activity is placed in its context, as indicated in block 30. For example, the context may be that the user has gazed at one target for a given amount of time. Another context may be that the user has blinked after providing another eye tracking software recognized indication. Thus, the context may be used by the system to interpret what the user meant by the eye tracker detected actuation. Then, in block 32, the eye activity and its context are analyzed to associate them with the desired user input. In other words, the context and the eye activity are associated with a command or control the user presumably meant to signal. Then, in block 34, a reader, control, or service may be implemented based on the detected activity and its associated context.

In some embodiments, two different types of facial tracker detected inputs may be provided. The first input may be a reading control input. Examples of reading controls may be to turn the page, to scroll the page, to show a menu, or to enable or disable voice inputs. In each of these cases, the user provides a camera detected command or input to control the process of reading text.

In some embodiments, a second type of user input may indicate a request for a user service. For example, a user service may be to request the pronunciation of a word that has been identified within the text. Another reader service may be to provide a definition of a particular word. Still another reader service may be to indicate or recognize that the user is having difficulty reading a particular passage, word, phrase, or even book. This information may be signaled to a monitor to indicate that the user is unable to easily handle the text. This may trigger the provision of a simpler text, a more complicated text, a larger text size, audible prompts, or teacher or monitor intervention, as examples. In addition, the location in the text where the reading difficulty was signaled, may be automatically recorded for access by others, such as a teacher.

Referring to FIG. 4, as one simple example, the user may fixate his or her gaze on a particular word, as detected in block 40. This may be determined from the video stream from the camera by identifying a lack of eye movement for a given threshold period of time. In response to the fixation on a particular target within the text, the targeted text may be identified. This may be done by matching the coordinates of the eye gaze with the associated text coordinates. As a result, a dictionary definition of the targeted word may be provided, as indicated in blocks 42 and 44.

If, thereafter, a user blink is detected at 46, the text definition may be removed from the display, as indicated in block 48. In this case, the context analysis determines that a blink after a fixation on a particular word and the display of its definition may be interpreted as a user input to remove the displayed text.

Then, in block 50; the regular reading mode is resumed in this example. In this embodiment, if the user holds his or her eyes closed for a given period of time, such as one second, as detected in block 52, the page may be turned (block 54). Other indications of a page turn command may be eyes scanning across the page or even fixation on the eyes on a page turn icon displayed in association with the text.

In order to avoid false inputs, a feedback mechanism may be provided. For example, when the user gazes at a particular word, the word may be highlighted to be sure that the system has detected the right word. The color of the highlighting may indicate what the system believes the user input to be. For example, if the user stares at the word “conch” for an extended period, that word may be highlighted in yellow, indicating that the system understands that the user wants the system to provide a definition of the word “conch.” However, in another embodiment, the system may highlight the word in red when, based on the context, the system believes that the user wants to receive a pronunciation guide to the word. The pronunciation guide may provide an indication in text of how to pronounce the word or may even include an audio pronunciation through a speech generation system. In response to the highlighting of the word or other feedback, the user can indicate through another eye actuation whether the system's understanding of the intended input is correct. The user may open his mouth to indicate a command like pronunciation.

In still another embodiment, a bookmark may be added to a page in order to enable the user to come back to the same position where the user left off. For example, in response to a unique eye actuation, a mark may be placed on the text page to provide the user a visual indication of where the user left off for subsequent resumption of reading. The bookmarks may be recorded and stored for future and/or remote access, separately or as part of the file that indicates text that was marked.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a display to display text to be read by a user;
a camera associated with the display; and
a control to detect user facial actuations and to interpret facial actuation to control the display of text.

2. The apparatus of claim 1 wherein said control to detect eye activity to control text display.

3. The apparatus of claim 1 wherein said control to associate eye activity and context to determine an intended user command.

4. The apparatus of claim 1, said control to recognize a facial actuation as a request to provide a meaning of a word in said text.

5. The apparatus of claim 1, said control to recognize a facial actuation as a control signal to request a display of a word pronunciation.

6. The apparatus of claim 1, said control to recognize a facial actuation to indicate difficulty reading the text.

7. The apparatus of claim 1, said control to recognize a facial actuation to indicate a request to mark a position on a page of text.

8. A method comprising:
displaying text to be read by a user;
recording an image of the user as the user reads the text;
detecting user facial actuations associated with said text; and
linking a facial actuation with a user input.

9. The method of claim 8 including associating eye activity and context to determine an intended user command.

10. The method of claim 8 including recognizing a facial actuation as a request to provide a meaning of a word in said text.

11. The method of claim 8 including recognizing a facial actuation as a control signal to request a display of a word pronunciation.

12. The method of claim 8 including recognizing a facial actuation as indicating difficulty reading the text.

13. The method of claim 8 including recognizing a facial actuation as indicating a request to mark a position on a page of text.

14. A computer readable medium storing instructions executed by a computer to:
display text to be read by a user;
record an image of the user as the user reads the text;
detect user facial actuations while reading said text; and
correlate a facial actuation with a particular portion of said text.

15. The medium of claim 14 further storing instructions to detect eye activity and to identify a gaze target in order to correlate the facial actuation to text.

16. The medium of claim 14 further storing instructions to associate eye activity and context to determine an intended user command.

17. The medium of claim 14 further storing instructions to recognize a facial actuation as a request to provide a meaning of a word in said text.

18. The medium of claim 14 further storing instructions to recognize a facial actuation as a control signal to request a word pronunciation.

19. The medium of claim 14 further storing instructions to recognize a facial actuation as indicating difficulty reading a portion of said text, identify said text portion, and record the location of said text portion.

20. The medium of claim 17 further storing instructions to recognize a facial actuation as indicating a request to mark a position on a page of text, record said position, and make said recorded position available for subsequent access.
